(19) United States
(12) Patent Application Publication
(10) Pub. No.: US 2012/0254073 A1
(43) Pub. Date: Oct. 4, 2012

(54) SYSTEM FOR FLOATING MASSAGE SERVICES

(76) Inventor: Fadhil Owed, Dearborn Heights, MI (US)

(21) Appl. No.: 13/078,149

(22) Filed: Apr. 1, 2011

(51) Int. Cl. G06Q 90/00

(52) U.S. Cl. 705/500

(57) ABSTRACT

The present invention pertains to a floating massage system made up of a scheduling system which schedules massages by predetermined increments of time, a floating structure with at least one support apparatus, a receptionist point, and a transport shuttle. The transport shuttle acts to transport a customer from the receptionist point to the floating structure for receipt of a massage scheduled by way of the scheduling system.

### FIELD OF THE INVENTION

The present invention relates to the art of massage services.

### STATEMENT REGARDING FEDERALLY-SPONSORED RESEARCH AND DEVELOPMENT

Not applicable.

### BACKGROUND OF THE INVENTION

Massage is a popular way to reduce stress and anxiety in individuals of all ages. Typically, since people that go for a massage are stressed or tense already, it is desirable not to deal with the extra burdens of the scheduling process and transportation to/from the scheduled session.

As massage has become more and more popular in today's fast paced society, massage services are often seen in public areas, such as on sidewalks, airports, shopping centers, or malls. One of the drawbacks of such locales is that they lack any sense of privacy. An individual would remain completely clothed during the massage session, preventing the massage specialist from being able to provide direct contact with the tense/stressed areas of the body. Another drawback of such public locales for massage services is that public locations do not take the individual outside of the stressful environment, making it much more difficult for the individual to relax and become stress free during a massage session. Such drawbacks are very counterproductive for the very reason people get a massage in the first place—to relax.

Yet another drawback with current massage practices is that even private massages are typically done in a closed off environment with no soothing ambiance. While the stresses of the outside/public environment are missing, it is not very soothing and relaxing to lie in a small, sterile room.

To this end, there is a need for a massage system where an individual in need of a massage can go and be provided with a very soothing and relaxing experience, from the point of scheduling to the actual massage, and all points in between.

### BRIEF DESCRIPTION OF THE SEVERAL VIEWS OF THE DRAWINGS

The foregoing summary, as well as the following detailed description of the invention, will be better understood when read in conjunction with the appended drawings. For illustrating the invention, the figures are shown in the embodiments that are presently preferred. It should be understood, however, that the invention is not limited to the precise arrangements and instrumentalities shown. In the drawings:

FIG. 1 depicts at least one embodiment of the invention, namely representative drawing of the system as disclosed in the present specification.

FIG. 2 depicts at least one embodiment of the invention, namely representative drawing of the system as disclosed in the present specification.

FIG. 3 depicts at least one embodiment of the invention, namely schematic representation of the system as disclosed in the present specification.

### DESCRIPTION OF THE INVENTION

The present invention depicts an inventive solution to the fore mentioned issues related to massage services.

Unless otherwise defined, all terms of art, notations and other scientific terms or terminology used herein are intended to have the meanings commonly understood by those of skill in the art to which this invention pertains. In some cases, terms with commonly understood meanings are defined herein for clarity and/or for ready reference, and the inclusion of such definitions herein should not necessarily be construed to represent a substantial difference over what is generally understood in the art. Many of the techniques and procedures described, or referenced herein, are well understood and commonly employed using conventional methodology by those skilled in the art.

The indefinite articles “a” and “an,” as used herein in the specification and in the claims, unless clearly indicated to the contrary, should be understood to mean “at least one.”

The phrase “and/or,” as used herein in the specification and in the claims, should be understood to mean “either or both” of the elements so conjoined, i.e., elements that are conjunctively present in some cases and disjunctively present in other cases. Other elements may optionally be present other than the elements specifically identified by the “and/or” clause, whether related or unrelated to those elements specifically identified unless clearly indicated to the contrary. Thus, as a non-limiting example, a reference to “A and/or B,” when used in conjunction with open-ended language such as “comprising” can refer, in one embodiment, to A without B (optionally including elements other than B); in another embodiment, to B without A (optionally including elements other than A); in yet another embodiment, to both A and B (optionally including other elements); etc.

As used herein in the specification and in the claims, or should be understood to have the same meaning as “and/or” as defined above. For example, when separating items in a list, or or “and/or” shall be interpreted as being inclusive, i.e., the inclusion of at least one, but also including more than one, of a number or list of elements, and, optionally, additional unlisted items. Only terms clearly indicated to the contrary, such as only one of or “exactly one of,” or, when used in the claims, “consisting of,” will refer to the inclusion of exactly one element of a number or list of elements. In general, the term or as used herein shall only be interpreted as indicating exclusive alternatives (i.e. “one or the other but not both”) when preceded by terms of exclusivity, such as “either,” “one of,” “only one of,” or “exactly one of.” “Consisting essentially of,” when used in the claims, shall have its ordinary meaning as used in the field of patent law.

The present invention pertains to a system for massaging a person comprising a floating structure and a support apparatus with the support apparatus positioned on the floating structure such that a person can position their body on the support apparatus for facilitation of massage.

The present invention also pertains to a floating massage system comprising at least one floating structure with at least one support apparatus, at least one receptionist point and at least one transport shuttle, wherein the at least one transport shuttle serves to transport a customer from the at least one receptionist point to the at least one floating structure for receipt of a massage.

The present invention also pertains to a floating massage system comprising a scheduling system which schedules massages by predetermined increments of time, at least one floating structure with at least one support apparatus, at least one receptionist point, and at least one transport shuttle. The at least one transport shuttle acts to transport a customer from the at least one receptionist point to the at least one floating structure for receipt of a massage scheduled by way of the scheduling system.

In at least one embodiment, the present invention pertains to a system for massaging a person, the system comprising a floating structure and a support apparatus, wherein the support apparatus is positioned on the floating structure, whereby a person can position their body on the support apparatus for facilitation of massage while on the floating structure.

As would be understood by those skilled in the art, the words “customer,” “individual,” “massage client” and “client” may be used interchangeably herein and refer to a person that wishes to receive a massage. Likewise, it would be understood that the singular form of each can also refer to the plural form (i.e. “client” and “clients”).

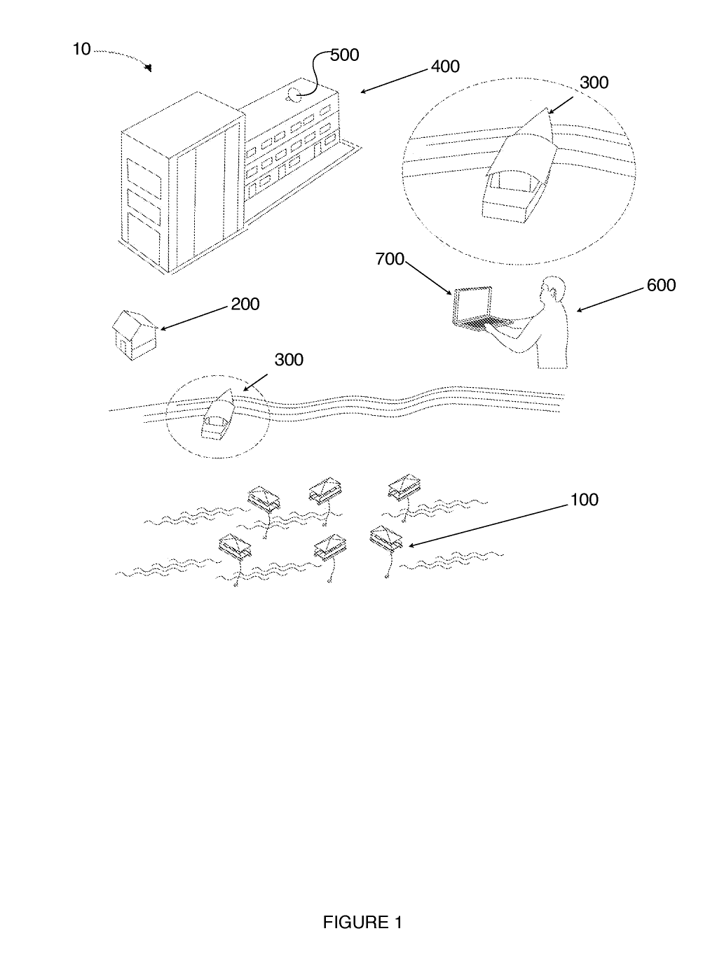

Referring now to the drawings in detail, in FIG. 1, a floating massage system, generally referred as 10, is depicted, the system comprising at least one floating structure 100 with at least one support apparatus, at least one receptionist point 200 and at least one transport shuttle 300, wherein the at least one transport shuttle 300 serves to transport a customer 600 from the at least one receptionist point 200 to the at least one floating structure 100 for receipt of a massage. In some embodiments, the receptionist point 200 may be located inside of a public building, resort or hotel 400. In other embodiments, the receptionist point 200 is located next to the body of water for easy access to the transport shuttle 300.

In at least one embodiment, the floating massage system 10 further comprises at least one wireless communication device for communication between the at least one floating structure 100 and the at least one receptionist point 200. The wireless communication device may consist of a portable computer, mobile phone, or any other handheld electronic communication device as would be understood by those skilled in the art. Likewise, at least one wireless communication device would be located at each of the floating structure 100, the receptionist point 200, and transport shuttle 300. In embodiments where communication is desired additionally between each point and the public building, hotel or resort 400 (or if the receptionist point 200 is located within the public building, hotel or resort), a wireless communication device would be included. In some embodiments, each wireless communication device would transmit signals via a wireless internet connection. In other embodiments, each wireless communication device would transmit signals via radio-waves. In other embodiments, each wireless communication device would transmit signals via bluetooth. In other embodiments, each wireless communication device would transmit signals via cellular signals. It would be understood by those skilled in the art that other methods of wireless communication may exist now, or in the future, that would work in the current system.

In some embodiments, a wireless relay device 500 may exist for a centralized communication point or relay between the floating structure 100, the receptionist point 200, the transport shuttle 300, and/or the public building, hotel or resort 400.

In at least one embodiment, the customer 600 can schedule their massage appointment online via a computer 700 connected to the massage system's website or database. The customer 600 can be located at the receptionist point 200 at the time of scheduling. The customer 600 could also be located at any place of convenience as long as they have a computer 700 and an internet connection for connected to the massage service's website and database.

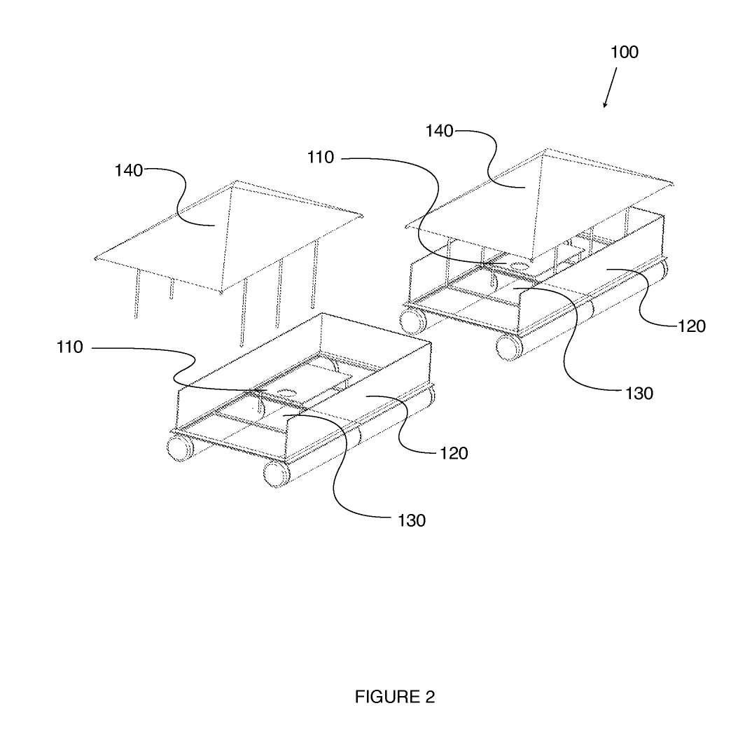

In FIG. 2, a system for massaging a person is depicted, the system comprising a floating structure 100 and a support apparatus 110 with the support apparatus 110 positioned on the floating structure 100 such that a person can position their body on the support apparatus 110 for facilitation of massage. The support apparatus 110, may comprise a chair, a bed a, hybrid bed/chair or any structure for positioning the body would serve the same function to achieve the same massage purposes. In some embodiments, a single floating structure 100 can accommodate more than one massage client. The floating structure 100 can contain multiple areas, or rooms, for additional support apparatuses 110. Furthermore, there may be multiple floating structures 100 within a certain area whereby one or more transport shuttles 300 can access them.

In at least one embodiment, the floating structure 100 is attached to the ground below a body of water by one or more attachment devices. The floating structure 100 may be anchored by one or more anchors or anchored buoy (as shown in FIG. 1). In some embodiments, the floating structure 100 may also have at least one wall 120. This wall 120 may be transparent to allow for a massage client to view their surroundings while on the floating structure 100. The transparency of the wall can be used from materials selected from the group consisting of glass, Plexiglas, acrylic and cloth. Other transparent materials may be used for the same purpose to achieve the same result.

In at least one embodiment, the floating structure 100 contains a transparent portion 130 such that a person can see into the water while positioned on the support apparatus. The transparent floor portion 130 is positioned such that the person can see into the water below the floating structure 100. In other embodiments, the floating structure 100 contains a sandy portion such that a person can see the sand while positioned on the support apparatus, giving the appearance of being on a beach. In some embodiments, the floating structure 100 contains a sandy portion in addition to a transparent portion 130 to allow for providing a feeling of being on a beach while viewing the underwater environment below the floating structure 100. In some embodiments, the support apparatus 110 (sometimes called massage table or seat) contains a hole such that the massage client's face can be inserted while they are laying on their stomach. This aids in the ability for the client to see below the support apparatus 110 and through the transparent portion 130 down into the water below.

In at least one embodiment, the floating structure 100 contains a transparent portion 130 such that a person can see into a fish-aquarium underneath the transparent portion 130. This embodiment is in case the body of water does not contain any fish or if the water is murky. The fish-aquarium may also be positioned on the side of the floating structure 100.

In at least one embodiment, the floating structure 100 further comprises at least one canopy 140. As shown in FIG. 2, the canopy 140 may be removable. It would also be understood by those skilled in the art that the canopy 140 may be permanently fixed. In some embodiments, the floating structure 100 may also include at least one curtain. In at least one embodiment, the system may also include a power source. The power source may be a solar-generated power source, a wind-generated power source, a wave-generated power source, a water-current generated power source, a gasoline-generated power source, a natural gas-generated power source, or a combination of any of the fore-mentioned power sources. The power source would provide electricity for things such as massage aids, music, lights, and any other things that one skilled in the art would use.

In at least one embodiment, the floating structure 100 further comprises lights. The lights are meant to provide ambiance for the massage client. Typically, the lighting would be dimmable such that the lighting can be adjusted to a massage client's liking. Lights can also be accomplished using candles and in particular scented candles or scented lumination sticks.

In at least one embodiment, the floating structure includes a sound generating device. Such a device may be a stereo system. The stereo system may be a surround sound stereo system to provide the massage client with sound effects from all angles. The sound generating device is meant to provide the massage client with soothing and relaxing ambience while receiving a massage.

Referring again to FIG. 1, in at least one embodiment, the floating massage system further comprises a receptionist point 200. The receptionist point 200 is typically located close to the body of water where the floating structure 100 is located for convenience of the client. The body of water may be an ocean, bay, lake, river or large pool. The receptionist point 200 is communicatively linked to the floating structure 100. Furthermore, the receptionist point 200 may be a mobile building. Communication between the floating structure 100 and the receptionist point 200 is done wirelessly by way of mobile devices and/or wireless internet connections. In some embodiments, the floating structure 100 contains a computer system onboard to allow for communication with the receptionist point 200. The communication between the two points allows for proper timing and arrangement of massage appointments and pickup/drop-off times for clients.

In at least one embodiment, the floating massage system further comprises a transport shuttle 300. The transport shuttle 300 provides a means to transport a massage client to and from the floating structure and the beach, shore, or receptionist point 200. The transport shuttle 300 is typically located near the receptionist point 200 for the convenience of the client. The transport shuttle 300 may further provide for drinks and food and comfortable seating for the enjoyment and relaxation of the client 600 during transit.

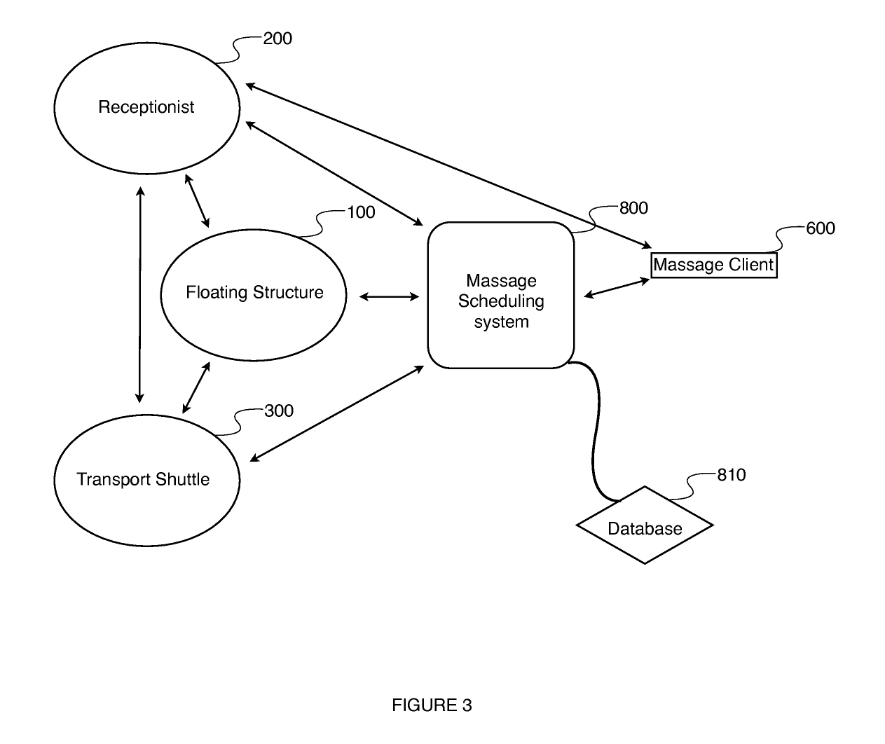

Referring to FIG. 3, in at least one embodiment, the floating massage system comprises a massage scheduling system 800, which schedules massages by predetermined increments of time. Additionally, the system comprises at least one floating structure 100 with at least one support apparatus; at least one receptionist point 200; and at least one transport shuttle 300. The at least one transport shuttle 300 acts to transport a customer, or massage client 600, from the at least one receptionist point 200 to the at least one floating structure 100 for receipt of a massage scheduled by way of the massage scheduling system 800.

The system provides for communication between each point in the system. The receptionist 200, floating structure 100, and transport shuttle 300 are capable of communicating back and forth with each other and with the massage scheduling system 800 such that no appointment is overlapped or improperly scheduled between clients. In some embodiments, the system would further include at least one wireless communication device. The wireless communication device provides a means for communication and coordination between the at least one floating structure 100, the at least one receptionist point 200, the at least one transport shuttle 300 and the scheduling system 800. The method of communication may be by voice, text, software interaction or computer input.

The scheduling system 800 is typically synced continuously between wireless communication devices and/or computer system(s) at each of the points in the floating massage system. Such a scheduling system prevents double-booking and provides a stream-lined system for movement of massage clients to/from receptionist points to floating structures.

In some embodiments, once the massage client 600 has booked their massage via the internet, or by phone, or mobile communication device, or in person at the receptionist 200, the appointment is saved into the massage scheduling system's database 810. This appointment is then communicated to each point within the system to ensure all points in the system are prepared and synced properly for a hassle-free and enjoyable experience for the client 600. At the time of the appointment, the massage client 600 appears at the receptionist point 200 and will be picked up at the edge of the body of water by the transport shuttle 300. The shuttle transports the client 600 to the floating structure 100. Once on the floating structure 100, the client 600 receives the services that they purchased and then at the designated time, the transport shuttle 300 arrives at the floating structure 100 to pick-up the client 600 for return to the shore. Final payment arrangements can be taken care of at the receptionist point 200 before or after the massage, or it can be prepaid online, in person, or by phone.

It is to be appreciated that the Detailed Description section, and not the Abstract section, is intended to be used to interpret the claims. The Abstract section may set forth one or more but not all exemplary embodiments of the present invention as contemplated by the inventor(s), and thus, are not intended to limit the present invention and the appended claims in any way.

The present invention has been described above with the aid of functional building blocks illustrating the implementation of specified functions and relationships thereof. The boundaries of these functional building blocks have been arbitrarily defined herein for the convenience of the description. Alternate boundaries can be defined so long as the specified functions and relationships thereof are appropriately performed.

The foregoing description of the specific embodiments will so fully reveal the general nature of the invention that others can, by applying knowledge within the skill of the art, readily modify and/or adapt for various applications such specific embodiments, without undue experimentation, without departing from the general concept of the present invention. Therefore, such adaptations and modifications are intended to be within the meaning and range of equivalents of the disclosed embodiments, based on the teaching and guidance presented herein. It is to be understood that the phraseology or terminology herein is for the purpose of description and not of limitation, such that the terminology or phraseology of the present specification is to be interpreted by the skilled artisan in light of the teachings and guidance. The breadth and scope of the present invention should not be limited by any of the above-described exemplary embodiments, but should be defined only in accordance with the following claims and their equivalents.

What is claimed is:

1. A system for massaging a person, the system comprising:
a floating structure,
at least one receptionist point; and
a support apparatus, wherein the support apparatus is positioned on the floating structure, whereby a person can position their body on the support apparatus for facilitation of massage while on the floating structure.

2. The system of claim 1, wherein the floating structure is attached to the ground below a body of water.

3. The system of claim 1, wherein the floating structure further comprises a transparent portion, whereby a person can see into the water while positioned on the support apparatus.

4. The system of claim 1, wherein the floating structure further comprises at least one canopy.

5. The system of claim 1, wherein the floating structure further comprises at least one curtain.

6. The system of claim 1, wherein the floating structure further comprises at least one fish-aquarium.

7. The system of claim 1, further comprising a power source.

8. The system of claim 10, wherein the power source is selected from the group consisting of solar-generated power, wind-generated power, wave-generated power, current-generated power, gasoline-generated power, natural gas-generated power and combinations thereof.

9. The system of claim 1, further comprising a sound generating device.

10. The system of claim 1, further comprising at least one wall, wherein the at least one wall is attached to the floating structure.

11. The system of claim 10, wherein the at least one wall is transparent.

12. The system of claim 1, further comprising a receptionist point communicatively linked to the floating structure.

13. The system of claim 1, further comprising at least one transport shuttle, wherein the at least one transport shuttle serves to transport a customer from the at least one receptionist point to the at least one floating structure for receipt of a massage.

14. The system of claim 1, further comprising a light arrangement.

15. A floating massage system, the system comprising:
a scheduling system which schedules massages by predetermined increments of time;
at least one floating structure with at least one support apparatus;
at least one receptionist point;
at least one transport shuttle, wherein the at least one transport shuttle acts to transport a customer from the at least one receptionist point to the at least one floating structure for receipt of a massage scheduled by way of the scheduling system.

16. The floating massage system of claim 15, the system further comprising at least one wireless communication device for communication and coordination between the at least one floating structure, the at least one receptionist point, the at least one transport shuttle, and the scheduling system.

17. A floating massage system comprising the steps of:
scheduling a space and time using at least one computer system;
coordinate a space and time using at least one receptionist;
transporting at least one person to the massage site using a shuttle; and
massaging at least one person on at least one floating structure.

18. The floating massage system of claim 17, the system further comprising at least one wireless communication device for communication and coordination between the at least one floating structure, the at least one receptionist point, the at least one transport shuttle, and the scheduling system.

19. The system of claim 17, further comprising a sound generating device and a light generating device.

20. The system of claim 17, wherein the at least one wall of said floating structure is transparent.
